(19) United States
(12) Patent Application Publication
(10) Pub. No.: US 2026/0205786 A1
(43) Pub. Date: Jul. 16, 2026

(54) Bluetooth peripheral apparatus, Bluetooth central apparatus and Bluetooth communication method having bi-directional communication mechanism

(71) Applicant: REALTEK SEMICONDUCTOR CORPORATION, HSINCHU (TW)

(72) Inventors: CHIH-WEI HO, HSINCHU (TW); YU-NUNG WEI, HSINCHU (TW); YU CHIANG, HSINCHU (TW)

(21) Appl. No.: 19/443,391

(22) Filed: Jan. 8, 2026

(30) Foreign Application Priority Data
Jan. 14, 2025 (TW) 114101552

(51) Int. Cl. H04W 4/80

(52) U.S. Cl. CPC H04W 4/80

(57) ABSTRACT

A Bluetooth communication method having bi-directional communication mechanism is provided including steps outlined below. A Bluetooth central apparatus and a Bluetooth peripheral apparatus perform a broadcast isochronous stream (BIS) communication according to a BIS technology. The Bluetooth central apparatus initiates one-way first packet communication behaviors performed with the Bluetooth peripheral apparatus operating under a normal transmission mode such that the Bluetooth peripheral apparatus does not react in response to the one-way first packet communication behaviors. The Bluetooth central apparatus initiates two-way second packet communication behaviors performed with the Bluetooth peripheral apparatus operating under a bi-directional transmission mode such that the Bluetooth peripheral apparatus such that the Bluetooth peripheral apparatus selects at least one selected two-way second packet communication behavior and actively initiates a signal transmission behavior performed with the Bluetooth central apparatus in response to the at least one selected two-way second packet communication behavior.

### BACKGROUND OF THE INVENTION

### 1. Field of the Invention

The present invention relates to a Bluetooth peripheral apparatus, a Bluetooth central apparatus and a Bluetooth communication method having a bi-directional communication mechanism.

### 2. Description of Related Art

Bluetooth is a wireless communication technology standard to allow a fixed apparatus and a mobile apparatus to exchange data within a short distance to form a personal area network (PAN). Broadcast Isochronous Stream (BIS) technology is a Bluetooth Low Energy (LE) audio technology developed on the basis of the Bluetooth technology standard to allow Bluetooth peripheral apparatuses in a Broadcast Isochronous Group (BIG) to receive the audio signal from a Bluetooth central apparatus in a synchronous manner.

However, in the current configuration of the technology, the Bluetooth central apparatus can only perform a one direction communication with the Bluetooth peripheral apparatuses, which is limited.

### SUMMARY OF THE INVENTION

In consideration of the problem of the prior art, an object of the present invention is to supply a Bluetooth peripheral apparatus, a Bluetooth central apparatus and a Bluetooth communication method having a bi-directional communication mechanism.

The present invention discloses a Bluetooth peripheral apparatus having a bi-directional communication mechanism that includes a communication circuit and a processing circuit. The processing circuit is electrically coupled to the communication circuit and is configured to perform a broadcast isochronous stream (BIS) communication through the communication circuit with a Bluetooth central apparatus by using a BIS technology, operate in a normal transmission mode to not react in response to a plurality of first packet communication behaviors performed with and initiated by the Bluetooth central apparatus in a one-way manner and operate in a bi-directional transmission mode to select at least one selected second packet communication behavior from a plurality of second packet communication behaviors performed with and initiated by the Bluetooth central apparatus and actively initiate a signal transmission behavior performed with the Bluetooth central apparatus corresponding to the at least one selected second packet communication behavior.

The present invention also discloses a Bluetooth central apparatus having a bi-directional communication mechanism that includes a communication circuit and a processing circuit. The processing circuit is electrically coupled to the communication circuit and is configured to perform a BIS communication through the communication circuit with a Bluetooth peripheral apparatus by using a BIS technology, initiate a plurality of first packet communication behaviors with the Bluetooth peripheral apparatus operated in a normal transmission mode in a one-way manner such that the Bluetooth peripheral apparatus does not react in response to the first packet communication behaviors and initiate a plurality of second packet communication behaviors with the Bluetooth peripheral apparatus operated in a bi-directional transmission mode such that the Bluetooth peripheral apparatus selects at least one selected second packet communication behavior from the second packet communication behaviors and actively initiates a signal transmission behavior performed with the Bluetooth central apparatus corresponding to the at least one selected second packet communication behavior.

The present invention further discloses a Bluetooth communication method having a bi-directional communication mechanism that includes steps outlined below. A BIS communication is performed between a Bluetooth central apparatus and a Bluetooth peripheral apparatus by using a BIS technology. A plurality of first packet communication behaviors are initiated by the Bluetooth central apparatus with the Bluetooth peripheral apparatus operated in a normal transmission mode in a one-way manner such that the Bluetooth peripheral apparatus does not react in response to the first packet communication behaviors. A plurality of second packet communication behaviors are initiated by the Bluetooth central apparatus with the Bluetooth peripheral apparatus operated in a bi-directional transmission mode such that the Bluetooth peripheral apparatus selects at least one selected second packet communication behavior from the second packet communication behaviors and actively initiates a signal transmission behavior performed with the Bluetooth central apparatus corresponding to the at least one selected second packet communication behavior.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a Bluetooth communication system according to an embodiment of the present invention.

FIG. 2 illustrates a signal timing diagram of the communication performed by the Bluetooth central apparatus with the Bluetooth peripheral apparatus and the Bluetooth peripheral apparatus operating in the normal transmission mode according to an embodiment of the present invention.

FIG. 3 illustrates a signal timing diagram of the communication performed by the Bluetooth central apparatus with the Bluetooth peripheral apparatus and the Bluetooth peripheral apparatus operating in the bi-directional transmission mode according to an embodiment of the present invention.

FIG. 4 illustrates a signal timing diagram of the communication performed by the Bluetooth central apparatus with the Bluetooth peripheral apparatus operating in the bi-directional transmission mode and the Bluetooth peripheral apparatus operating in the normal transmission mode according to an embodiment of the present invention.

FIG. 5 illustrates a signal timing diagram of the communication performed by the Bluetooth central apparatus with the Bluetooth peripheral apparatus and the Bluetooth peripheral apparatus according to an embodiment of the present invention.

FIG. 6 illustrates a flow chart of a Bluetooth communication method according to an embodiment of the present invention.

### DETAILED DESCRIPTION OF THE PREFERRED EMBODIMENTS

An aspect of the present invention is to provide a Bluetooth peripheral apparatus, a Bluetooth central apparatus and a Bluetooth communication method having a bi-directional communication mechanism to allow the Bluetooth peripheral apparatus that operates in a bi-directional transmission mode to actively initiate a signal transmission behavior with the Bluetooth central apparatus corresponding to a selected packet communication behavior to accomplish the object of bi-directional communication under the broadcast isochronous stream (BIS) technology.

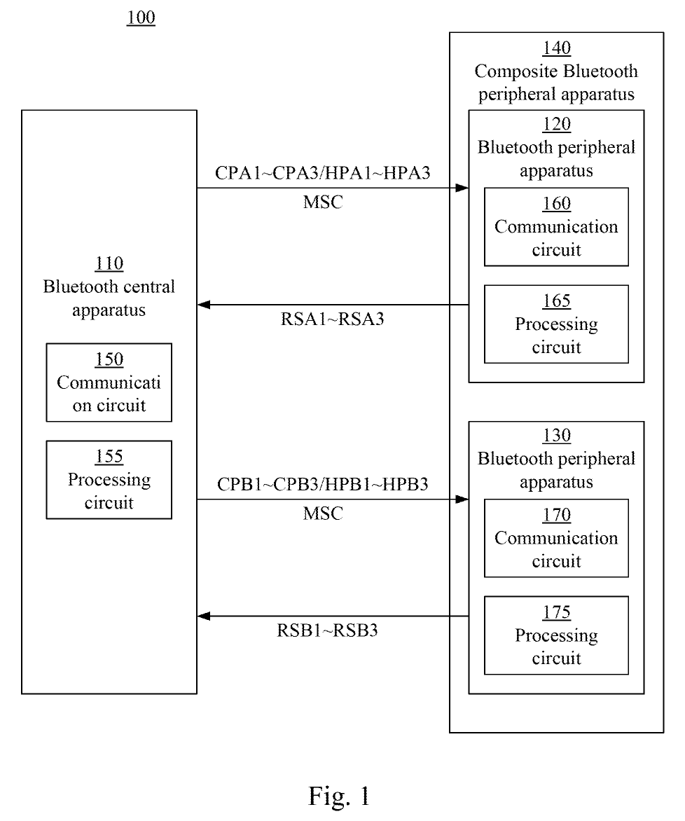

Reference is now made to FIG. 1. FIG. 1 illustrates a block diagram of a Bluetooth communication system 100 according to an embodiment of the present invention. The Bluetooth communication system 100 includes a Bluetooth central apparatus 110, a Bluetooth peripheral apparatus 120 and a Bluetooth peripheral apparatus 130.

The Bluetooth central apparatus 110, according to a Broadcast Isochronous Stream (BIS) technology, performs a BIS communication with the Bluetooth peripheral apparatus 120 and the Bluetooth peripheral apparatus 130.

In an embodiment, the Bluetooth central apparatus 110 is such as, but not limited to a smart phone, a tablet PC or other apparatuses that is able to provide an audio signal by using the BIS technology under the Bluetooth protocol.

In an embodiment, each of the Bluetooth peripheral apparatus 120 and the Bluetooth peripheral apparatus 130 is one of a plurality of sub-apparatuses included by a composite Bluetooth peripheral apparatus 140. The composite Bluetooth peripheral apparatus 140 is such as, but not limited to an earpiece, a speaker or other apparatuses that is able to receive the audio signal by using the BIS technology under the Bluetooth protocol such that the sub-apparatuses included therein together form a Broadcast Isochronous Group (BIG).

For example, when the composite Bluetooth peripheral apparatus 140 is the earpiece, two sub-apparatuses corresponding to the left ear and the right ear can be included to correspond to the Bluetooth peripheral apparatus 120 and the Bluetooth peripheral apparatus 130. In other embodiments, the number of the sub-apparatuses included by the composite Bluetooth peripheral apparatus 140 can be more than two. For example, when the composite Bluetooth peripheral apparatus 140 is a speaker, more than two sub-apparatuses corresponding to a multiple of sound channels can be included.

The Bluetooth central apparatus 110 includes a communication circuit 150 and a processing circuit 155. The processing circuit 155 is electrically coupled to the communication circuit 150 to perform the BIS communication with each of the Bluetooth peripheral apparatus 120 and the Bluetooth peripheral apparatus 130 in a one-to-one manner through the communication circuit 150. More specifically, instead of a one-to-one connection, the Bluetooth central apparatus 110 and the Bluetooth peripheral apparatus 120 and the Bluetooth peripheral apparatus 130 perform communication in a broadcast form.

The Bluetooth peripheral apparatus 120 includes a communication circuit 160 and a processing circuit 165. The processing circuit 165 is electrically coupled to the communication circuit 160 to perform the BIS communication with the Bluetooth central apparatus 110 in a one-to-one manner through the communication circuit 160. The Bluetooth peripheral apparatus 130 includes a communication circuit 170 and a processing circuit 175. The processing circuit 175 is electrically coupled to the communication circuit 170 to perform the BIS communication with the Bluetooth central apparatus 110 in a one-to-one manner through the communication circuit 170.

Each of the Bluetooth peripheral apparatus 120 and the Bluetooth peripheral apparatus 130 may operate in a normal transmission mode such that the Bluetooth central apparatus 110 performs communication with the Bluetooth peripheral apparatus 120 and the Bluetooth peripheral apparatus 130 operating in the normal transmission mode according to the BIS technology. The description of the operation of the Bluetooth central apparatus 110, the Bluetooth peripheral apparatus 120 and the Bluetooth peripheral apparatus 130 in the following paragraphs can be performed by the processing circuits in these apparatuses through the use of the communication circuits therein.

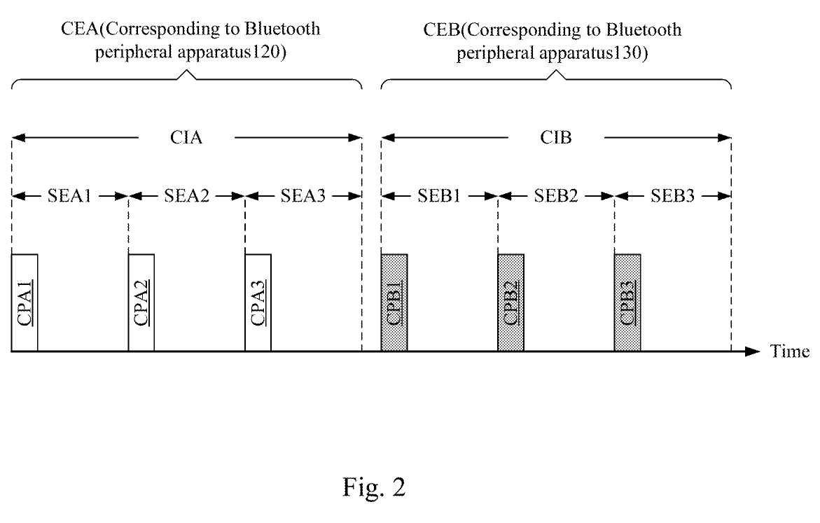

Reference is now made to FIG. 2. FIG. 2 illustrates a signal timing diagram of the communication performed by the Bluetooth central apparatus 110 with the Bluetooth peripheral apparatus 120 and the Bluetooth peripheral apparatus 130 operating in the normal transmission mode according to an embodiment of the present invention. In FIG. 2, the X-axis stands for time.

The Bluetooth central apparatus 110 initiates a plurality of first packet communication behaviors CPA1~CPA3 illustrated as white blocks with the Bluetooth peripheral apparatus 120 that operates in the normal transmission mode in a one-way manner such that the Bluetooth peripheral apparatus 120 does not react in response to the first packet communication behaviors CPA1~CPA3. The first packet communication behaviors CPA1~CPA3 are performed by the Bluetooth central apparatus 110 to transmit packets to the Bluetooth peripheral apparatus 120 such that the Bluetooth peripheral apparatus 120 receives the packets. The packets transmitted can be such as, but not limited to audio data packets.

In an embodiment, each of the first packet communication behaviors CPA1~CPA3 corresponds to one of a plurality of subevents SEA1~SEA3 in a BIS interval CIA of a BIS event CEA in a one-to-one manner. The subevent SEA1 is used to sequentially perform the first packet communication behavior CPA1. The subevent SEA2 is used to sequentially perform the first packet communication behavior CPA2. The subevent SEA3 is used to sequentially perform the first packet communication behavior CPA3.

Similarly, the Bluetooth central apparatus 110 performs a plurality of first packet communication behaviors CPB1~CPB3 illustrated as gray blocks with the Bluetooth peripheral apparatus 130 that operates in the normal transmission mode in a one-way manner such that the Bluetooth peripheral apparatus 130 does not react in response to the first packet communication behaviors CPB1~CPB3. The first packet communication behaviors CPB1~CPB3 are performed by the Bluetooth central apparatus 110 to transmit packets to the Bluetooth peripheral apparatus 130 such that the Bluetooth peripheral apparatus 130 receives the packets. The packets transmitted can be such as, but not limited to audio data packets.

In an embodiment, each of the first packet communication behaviors CPB1~CPB3 corresponds to one of a plurality of subevents SEB1~SEB3 in a BIS interval CIB of a BIS event CEB in a one-to-one manner. The subevent SEB1 is used to sequentially perform the first packet communication behavior CPB1. The subevent SEB2 is used to sequentially perform the first packet communication behavior CPB2. The subevent SEB3 is used to sequentially perform the first packet communication behavior CPB3.

On the other hand, in order to allow the Bluetooth central apparatus 110 to perform a bi-directional communication with the Bluetooth peripheral apparatus 120 and the Bluetooth peripheral apparatus 130 in the BIS technology, the Bluetooth central apparatus 110, the Bluetooth peripheral apparatus 120 and the Bluetooth peripheral apparatus 130 may have a bi-directional communication mechanism to allow the Bluetooth peripheral apparatus 120 and the Bluetooth peripheral apparatus 130 to operate in a bi-directional transmission mode such that the Bluetooth central apparatus 110 performs the bi-directional communication with the Bluetooth peripheral apparatus 120 and the Bluetooth peripheral apparatus 130 in the bi-directional transmission mode.

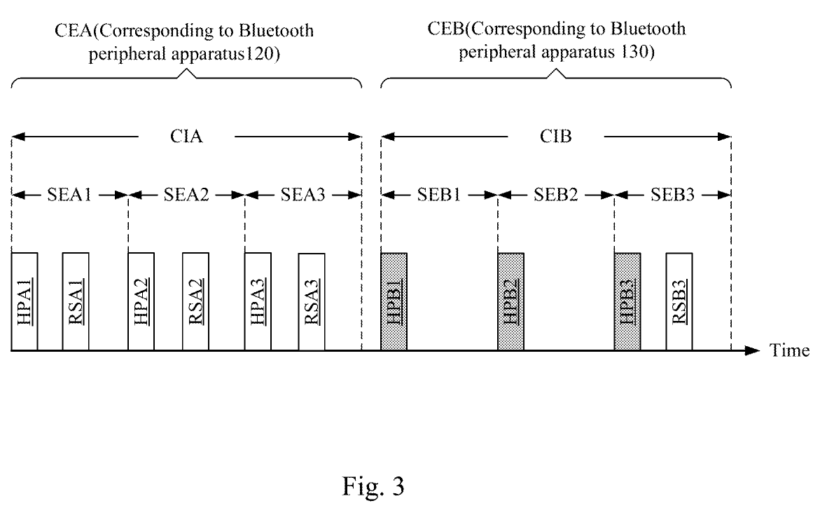

Reference is now made to FIG. 3. FIG. 3 illustrates a signal timing diagram of the communication performed by the Bluetooth central apparatus 110 with the Bluetooth peripheral apparatus 120 and the Bluetooth peripheral apparatus 130 operating in the bi-directional transmission mode according to an embodiment of the present invention. In FIG. 3, the X-axis stands for time.

The Bluetooth central apparatus 110 initiates a plurality of second packet communication behaviors HPA1~HPA3 illustrated as white blocks with the Bluetooth peripheral apparatus 120 operated in the bi-directional transmission mode. In response, the Bluetooth peripheral apparatus 120 selects at least one selected second packet communication behavior from the second packet communication behaviors HPA1~HPA3 and actively initiates a signal transmission behavior performed with the Bluetooth central apparatus 110 corresponding to the at least one selected second packet communication behavior.

The second packet communication behaviors HPA1~HPA3 are performed by the Bluetooth central apparatus 110 to transmit packets to the Bluetooth peripheral apparatus 120 such that the Bluetooth peripheral apparatus 120 receives the packets. The packets transmitted can be such as, but not limited to audio data packets. In the present embodiment, the selected second packet communication behaviors are the second packet communication behaviors HPA1~HPA3. The Bluetooth peripheral apparatus 120 actively initiates the signal transmission behaviors RSA1~RSA3 performed with the Bluetooth central apparatus 110 corresponding to the second packet communication behaviors HPA1~HPA3.

In an embodiment, similar to the first packet communication behaviors CPA1~CPA3, each of the second packet communication behaviors HPA1~HPA3 corresponds to one of a plurality of subevents SEA1~SEA3 in a BIS interval CIA of a BIS event CEA in a one-to-one manner. As a result, the subevent SEA1 sequentially includes the second packet communication behavior HPA1 the and signal transmission behavior RSA1. The subevent SEA2 sequentially includes the second packet communication behavior HPA2 and the signal transmission behavior RSA2. The subevents SEA3 sequentially includes the second packet communication behavior HPA3 and signal transmission behavior RSA3.

Similarly, the Bluetooth central apparatus 110 initiates a plurality of second packet communication behaviors HPB1~HPB3 illustrated as gray blocks with the Bluetooth peripheral apparatus 130 operated in the bi-directional transmission mode. In response, the Bluetooth peripheral apparatus 130 selects at least one selected second packet communication behavior from the second packet communication behaviors HPB1~HPB3 and actively initiates a signal transmission behavior performed with the Bluetooth central apparatus 110 corresponding to the at least one selected second packet communication behavior.

The second packet communication behaviors HPB1~HPB3 are performed by the Bluetooth central apparatus 110 to transmit packets to the Bluetooth peripheral apparatus 120 such that the Bluetooth peripheral apparatus 120 receives the packets. The packets transmitted can be such as, but not limited to audio data packets. In the present embodiment, the selected second packet communication behavior is the second packet communication behavior HPB3. The Bluetooth peripheral apparatus 120 actively initiates the signal transmission behavior RSB3 performed with the Bluetooth central apparatus 110 corresponding to the second packet communication behavior HPB3.

In an embodiment, similar to the first packet communication behaviors CPB1~CPB3, each of the second packet communication behaviors HPB1~HPB3 corresponds to one of a plurality of subevents SEB1~SEB3 in a BIS interval CIB of a BIS event CEB in a one-to-one manner. As a result, the subevent SEB1 only includes the second packet communication behavior HPB1. The subevents SEB2 only includes the second packet communication behavior HPB2. Since the second packet communication behavior HPB3 is the selected second packet communication behavior, the subevent SEB3 sequentially includes the second packet communication behavior HPB3 and signal transmission behavior RSB3.

As a result, by actively initiating the signal transmission behavior corresponding to the selected second packet communication behavior, a bi-directional communication can be performed by the Bluetooth peripheral apparatus 120 and Bluetooth peripheral apparatus 130 in the BIS technology that originally allows only the one-way communication.

In an embodiment, when the Bluetooth peripheral apparatus 120 and the Bluetooth peripheral apparatus 130 are such as, but not limited to speakers of a home theater system and are equipped with microphones, the Bluetooth peripheral apparatus 120 and the Bluetooth peripheral apparatus 130 can thus transmit an audio signal generated by the microphones by using the signal transmission behavior to the Bluetooth central apparatus 110.

In another embodiment, the Bluetooth peripheral apparatus 120 and the Bluetooth peripheral apparatus 130 may transmit such as, but not limited to information of channel scanning by using the signal transmission behavior to the Bluetooth central apparatus 110, such that the Bluetooth central apparatus 110 may select other channels suitable for performing the BIS communication with the Bluetooth peripheral apparatus 120 and the Bluetooth peripheral apparatus 130 when a severe interference occurs to a specific channel in the neighboring area.

It is appreciated that the composite Bluetooth peripheral apparatus 140 can be configured such that a first part of the sub-apparatuses included therein operate in the bi-directional transmission mode and a second part of the sub-apparatuses included therein operate in either the bi-directional transmission mode or the normal transmission mode. In the embodiment of FIG. 3, the condition that both of the Bluetooth peripheral apparatus 120 and the Bluetooth peripheral apparatus 130 in the composite Bluetooth peripheral apparatus 140 operate in the bi-directional transmission mode is used as an example. In other embodiments, the composite Bluetooth peripheral apparatus 140 may be configured such that the Bluetooth peripheral apparatus 120 operates in the bi-directional transmission mode and the Bluetooth peripheral apparatus 130 operates in the normal transmission mode.

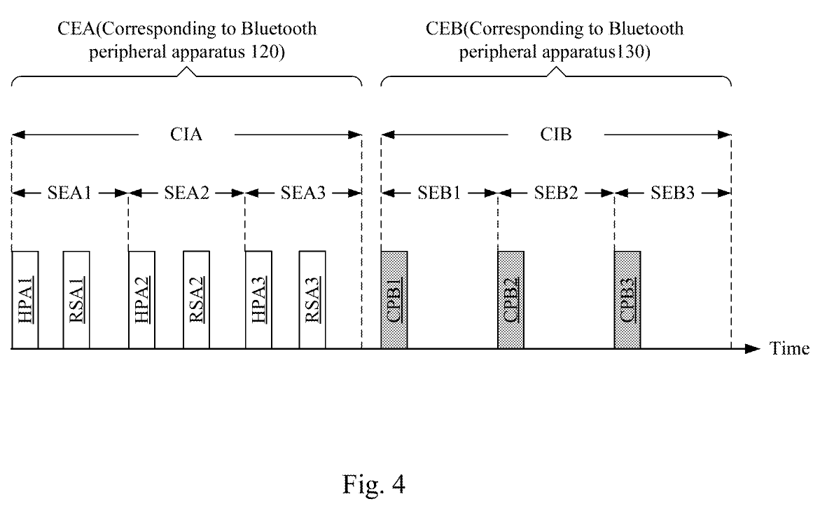

Reference is now made to FIG. 4. FIG. 4 illustrates a signal timing diagram of the communication performed by the Bluetooth central apparatus 110 with the Bluetooth peripheral apparatus 120 operating in the bi-directional transmission mode and the Bluetooth peripheral apparatus 130 operating in the normal transmission mode according to an embodiment of the present invention. In FIG. 4, the X-axis stands for time.

In FIG. 4, the signal timing of the Bluetooth peripheral apparatus 120 operating in the bi-directional transmission mode is actually the same as that in FIG. 3. The signal timing of the Bluetooth peripheral apparatus 130 operating in the normal transmission mode is actually the same as that in FIG. 2. The detail is not described herein.

By using the configuration that the Bluetooth peripheral apparatus 120 operates in the bi-directional transmission mode and the Bluetooth peripheral apparatus 130 operates in the normal transmission mode, the composite Bluetooth peripheral apparatus 140 may perform the bi-directional communication with the Bluetooth central apparatus 110 by using only the Bluetooth peripheral apparatus 120.

It is appreciated that the number of the second packet communication behaviors and the number of the selected second packet communication behavior included in one BIS event are merely an example. The present invention is not limited thereto.

In the embodiments of FIG. 3 and FIG. 4, the BIS events that the sub-apparatuses (i.e., the Bluetooth peripheral apparatus 120 and the Bluetooth peripheral apparatus 130) correspond to, which are the BIS event CEA and the BIS event CEB are arranged in a sequential manner. More specifically, the timing of the BIS event CEB is arranged behind the timing of the BIS event CEA such that the packet communication behaviors related to the Bluetooth peripheral apparatus 120 are performed first and the packet communication behaviors related to the Bluetooth peripheral apparatus 130 are performed subsequently.

In other embodiments, the BIS events that the sub-apparatuses included by the Bluetooth peripheral apparatus 140 correspond to are arranged in an interleaved manner such that K-th subevents of the BIS intervals of all the sub-apparatuses are arranged in a sequential manner, and K+1 subevents of the BIS intervals of all the sub-apparatuses are arranged in a sequential manner behind the K-th subevents of the BIS intervals of all the sub-apparatuses, in which K is an integer larger than 0.

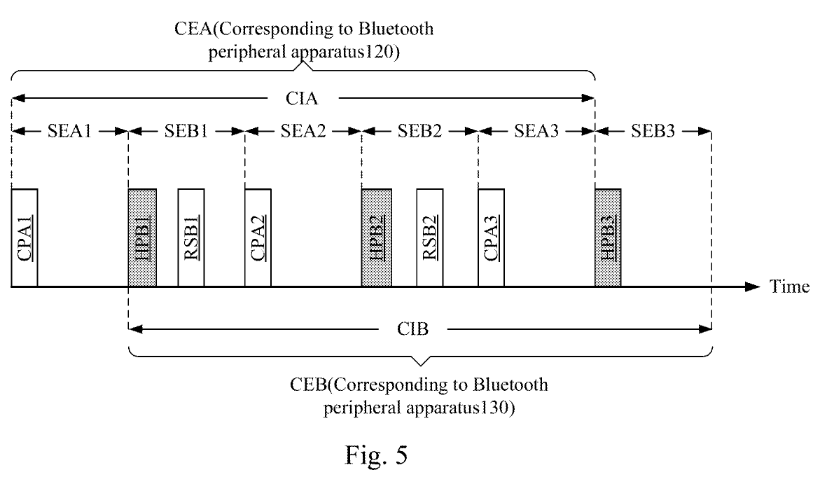

Reference is now made to FIG. 5. FIG. 5 illustrates a signal timing diagram of the communication performed by the Bluetooth central apparatus 110 with the Bluetooth peripheral apparatus 120 and the Bluetooth peripheral apparatus 130 according to an embodiment of the present invention. In FIG. 5, the X-axis stands for time.

As illustrated in FIG. 5, the first subevent SEA1 in the BIS interval CIA that the Bluetooth peripheral apparatus 120 corresponds to and the first subevent SEB1 in the BIS interval CIB that the Bluetooth peripheral apparatus 130 corresponds to are arranged in a sequential manner.

The second subevent SEA2 in the BIS interval CIA that the Bluetooth peripheral apparatus 120 corresponds and the second subevent SEB2 in the BIS interval CIB that the Bluetooth peripheral apparatus 130 corresponds to are arranged in a sequential manner behind the subevent SEA1 and subevent SEB1.

The third subevent SEA3 in the BIS interval CIA that the Bluetooth peripheral apparatus 120 corresponds and the third subevent SEB3 in the BIS interval CIB that the Bluetooth peripheral apparatus 130 corresponds to are arranged in a sequential manner behind the subevent SEA2 and subevent SEB2.

In the present embodiment, the Bluetooth peripheral apparatus 120 operates in the normal transmission mode such that the subevent SEA1 only includes the first packet communication behavior CPA1, the subevent SEA2 only includes the first packet communication behavior CPA2, and the subevent SEA3 only includes the first packet communication behavior CPA3.

In the present embodiment, the Bluetooth peripheral apparatus 130 operates in the bi-directional transmission mode such that the subevent SEB1 sequentially includes the second packet communication behavior HPB1 and the signal transmission behavior RSB1, the subevent SEB2 sequentially includes the second packet communication behavior HPB2 and the signal transmission behavior RSB2, and the subevent SEB3 only includes the second packet communication behavior HPB3.

It is appreciated that the embodiment described above uses the condition that the Bluetooth peripheral apparatus 120 operates in the normal transmission mode and the Bluetooth peripheral apparatus 130 operates in the bi-directional transmission mode as an example. However, the behaviors arranged in the interlaced manner can be applied to various kinds of combinations of the transmission modes that the Bluetooth peripheral apparatus 120 and the Bluetooth peripheral apparatus 130 operate, e.g., in the combination that both of the apparatuses are operated in the bi-directional transmission mode or a first one of the apparatuses operates in the normal transmission mode and a second one of the apparatuses operates in the bi-directional transmission mode.

In an embodiment, the Bluetooth central apparatus 110 transmits a mode switching command MSC to the Bluetooth peripheral apparatus 120 and the Bluetooth peripheral apparatus 130 such that the Bluetooth peripheral apparatus 120 and the Bluetooth peripheral apparatus 130 receive the mode switching command MSC to either switch from the normal transmission mode to the bi-directional transmission mode or from the bi-directional transmission mode to the normal transmission mode. In an embodiment, the mode switching command MSC can be transmitted in any subevent in the CIS interval of one CIS event or a control subevent additionally included. In another embodiment, the Bluetooth peripheral apparatus 120 and the Bluetooth peripheral apparatus 130 may be configured to operate in either the normal transmission mode or the bi-directional transmission mode after being manufactured. The present invention is not limited thereto.

As a result, the Bluetooth peripheral apparatus and Bluetooth central apparatus having the bi-directional communication mechanism allow the Bluetooth peripheral apparatus that operates in a bi-directional transmission mode to actively initiate the signal transmission behavior with the Bluetooth central apparatus corresponding to the selected packet communication behavior to accomplish the object of bi-directional communication under the BIS technology.

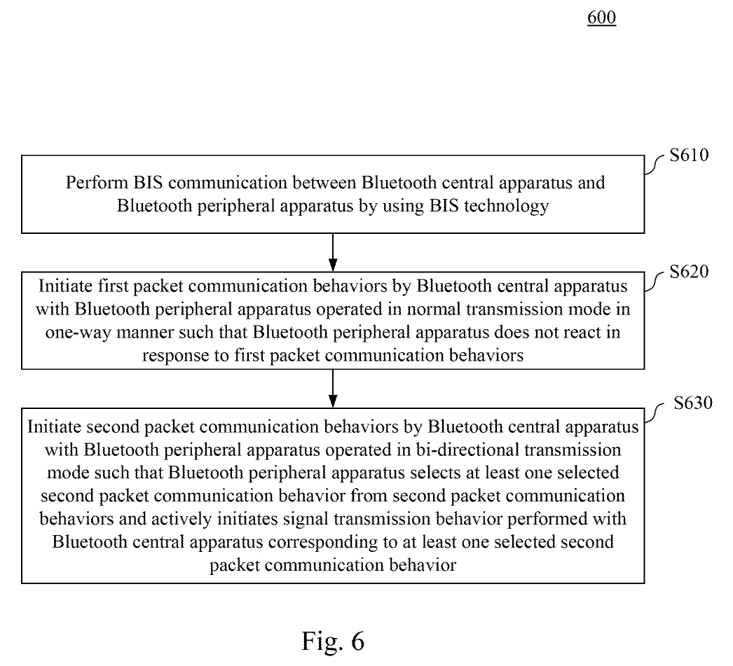

Reference is now made to FIG. 6. FIG. 6 illustrates a flow chart of a Bluetooth communication method 600 having a bi-directional communication mechanism according to an embodiment of the present invention.

In addition to the apparatus described above, the present disclosure further provides the Bluetooth communication method 600 having the bi-directional communication mechanism that can be used in such as, but not limited to, the Bluetooth central apparatus 110, the Bluetooth peripheral apparatus 120 and the Bluetooth peripheral apparatus 130 in FIG. 1. As illustrated in FIG. 6, an embodiment of the Bluetooth communication method 600 includes the following steps.

In step S610, the BIS communication is performed between the Bluetooth central apparatus 110 and the Bluetooth peripheral apparatus 120 (and/or the Bluetooth peripheral apparatus 130) by using the BIS technology.

In step S620, the first packet communication behaviors CPB1~CPB3 are initiated by the Bluetooth central apparatus 110 with the Bluetooth peripheral apparatus (e.g., the Bluetooth peripheral apparatus 130) operated in the normal transmission mode in the one-way manner such that the Bluetooth peripheral apparatus 130 does not react in response to the first packet communication behaviors CPB1~CPB3.

In step S630, the second packet communication behaviors HPA1~HPA3 are initiated by the Bluetooth central apparatus 110 with the Bluetooth peripheral apparatus (e.g., the Bluetooth peripheral apparatus 120) operated in the bi-directional transmission mode such that the Bluetooth peripheral apparatus 120 selects at least one selected second packet communication behavior (e.g., the second packet communication behaviors HPA1~HPA3) from the second packet communication behaviors HPA1~HPA3 and actively initiates the signal transmission behavior performed with the Bluetooth central apparatus 110 corresponding to the at least one selected second packet communication behavior.

It is appreciated that the embodiments described above are merely an example. In other embodiments, it should be appreciated that many modifications and changes may be made by those of ordinary skill in the art without departing, from the spirit of the disclosure.

For example, Bluetooth central apparatus may perform communication with a single Bluetooth peripheral apparatus communication or a composite Bluetooth peripheral apparatus communication that includes any number of sub-apparatuses and apply the bi-directional transmission mechanism thereto. The composite Bluetooth peripheral apparatus may be configured such that all the sub-apparatuses may operate in the bi-directional transmission mode, or only a part of an arbitrary number of the sub-apparatuses operate in the bi-directional transmission mode and another part of an arbitrary number of the sub-apparatuses operate in the normal transmission mode.

In summary, the present invention discloses the Bluetooth peripheral apparatus, the Bluetooth central apparatus and the Bluetooth communication method having the bi-directional communication mechanism allow the Bluetooth peripheral apparatus that operates in a bi-directional transmission mode to actively initiate the signal transmission behavior with the Bluetooth central apparatus corresponding to the selected packet communication behavior to accomplish the object of bi-directional communication under the BIS technology.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A Bluetooth peripheral apparatus having a bi-directional communication mechanism, comprising:
a communication circuit; and
a processing circuit electrically coupled to the communication circuit and configured to:
perform a broadcast isochronous stream (BIS) communication through the communication circuit with a Bluetooth central apparatus by using a BIS technology;
operate in a normal transmission mode to not react in response to a plurality of first packet communication behaviors performed with and initiated by the Bluetooth central apparatus in a one-way manner; and
operate in a bi-directional transmission mode to select at least one selected second packet communication behavior from a plurality of second packet communication behaviors performed with and initiated by the Bluetooth central apparatus and actively initiate a signal transmission behavior performed with the Bluetooth central apparatus corresponding to the at least one selected second packet communication behavior.

2. The Bluetooth peripheral apparatus of claim 1, wherein the second packet communication behaviors correspond to a plurality of subevents in a BIS interval of a BIS event in a one-to-one manner.

3. The Bluetooth peripheral apparatus of claim 2, wherein the Bluetooth peripheral apparatus is one of a plurality of sub-apparatuses comprised by a composite Bluetooth peripheral apparatus to collectively perform the BIS communication with the Bluetooth central apparatus, wherein a first part of the sub-apparatuses operate in the bi-directional transmission mode and a second part of the sub-apparatuses operate in either the bi-directional transmission mode or the normal transmission mode wherein.

4. The Bluetooth peripheral apparatus of claim 3, wherein the BIS events that the sub-apparatuses correspond to are arranged in a sequential manner.

5. The Bluetooth peripheral apparatus of claim 3, wherein the BIS events that the sub-apparatuses correspond to are arranged in an interleaved manner such that K-th subevents of the BIS intervals of all the sub-apparatuses are arranged in a sequential manner, and K+1 subevents of the BIS intervals of all the sub-apparatuses are arranged in a sequential manner behind the K-th subevents of the BIS intervals of all the sub-apparatuses, in which K is an integer larger than 0.

6. The Bluetooth peripheral apparatus of claim 1, wherein the processing circuit is configured to receive a mode switching command from the Bluetooth central apparatus to either switch from the normal transmission mode to the bi-directional transmission mode or from the bi-directional transmission mode to the normal transmission mode.

7. The Bluetooth peripheral apparatus of claim 6, wherein the mode switching command is transmitted in a control subevent of a BIS interval of a BIS event.

8. A Bluetooth central apparatus having a bi-directional communication mechanism, comprising:
a communication circuit; and
a processing circuit electrically coupled to the communication circuit and configured to:
perform a broadcast isochronous stream (BIS) communication through the communication circuit with a Bluetooth peripheral apparatus by using a BIS technology;
initiate a plurality of first packet communication behaviors with the Bluetooth peripheral apparatus operated in a normal transmission mode in a one-way manner such that the Bluetooth peripheral apparatus does not react in response to the first packet communication behaviors; and
initiate a plurality of second packet communication behaviors with the Bluetooth peripheral apparatus operated in a bi-directional transmission mode such that the Bluetooth peripheral apparatus selects at least one selected second packet communication behavior from the second packet communication behaviors and actively initiates a signal transmission behavior performed with the Bluetooth central apparatus corresponding to the at least one selected second packet communication behavior.

9. The Bluetooth central apparatus of claim 8, wherein the second packet communication behaviors correspond to a plurality of subevents in a BIS interval of a BIS event in a one-to-one manner.

10. The Bluetooth central apparatus of claim 9, wherein the Bluetooth peripheral apparatus is one of a plurality of sub-apparatuses comprised by a composite Bluetooth peripheral apparatus to collectively perform the BIS communication with the Bluetooth central apparatus, wherein a first part of the sub-apparatuses operate in the bi-directional transmission mode and a second part of the sub-apparatuses operate in either the bi-directional transmission mode or the normal transmission mode wherein.

11. The Bluetooth central apparatus of claim 10, wherein the BIS events that the sub-apparatuses correspond to are arranged in a sequential manner.

12. The Bluetooth central apparatus of claim 10, wherein the BIS events that the sub-apparatuses correspond to are arranged in an interleaved manner such that K-th subevents of the BIS intervals of all the sub-apparatuses are arranged in a sequential manner, and K+1 subevents of the BIS intervals of all the sub-apparatuses are arranged in a sequential manner behind the K-th subevents of the BIS intervals of all the sub-apparatuses, in which K is an integer larger than 0.

13. The Bluetooth central apparatus of claim 8, wherein the processing circuit is configured to transmit a mode switching command through the communication circuit to switch the Bluetooth peripheral apparatus from the normal transmission mode to the bi-directional transmission mode or from the bi-directional transmission mode to the normal transmission mode.

14. The Bluetooth central apparatus of claim 13, wherein the mode switching command is transmitted in a control subevent of a BIS interval of a BIS event.

15. A Bluetooth communication method having a bi-directional communication mechanism, comprising:
performing a broadcast isochronous stream (BIS) communication between a Bluetooth central apparatus and a Bluetooth peripheral apparatus by using a BIS technology;
initiate a plurality of first packet communication behaviors by the Bluetooth central apparatus with the Bluetooth peripheral apparatus operated in a normal transmission mode in a one-way manner such that the Bluetooth peripheral apparatus does not react in response to the first packet communication behaviors; and
initiate a plurality of second packet communication behaviors by the Bluetooth central apparatus with the Bluetooth peripheral apparatus operated in a bi-directional transmission mode such that the Bluetooth peripheral apparatus selects at least one selected second packet communication behavior from the second packet communication behaviors and actively initiates a signal transmission behavior performed with the Bluetooth central apparatus corresponding to the at least one selected second packet communication behavior.

16. The Bluetooth communication method of claim 15, wherein the second packet communication behaviors correspond to a plurality of subevents in a BIS interval of a BIS event in a one-to-one manner.

17. The Bluetooth communication method of claim 16, the Bluetooth peripheral apparatus is one of a plurality of sub-apparatuses comprised by a composite Bluetooth peripheral apparatus to collectively perform the BIS communication with the Bluetooth central apparatus, wherein a first part of the sub-apparatuses operate in the bi-directional transmission mode and a second part of the sub-apparatuses operate in either the bi-directional transmission mode or the normal transmission mode wherein.

18. The Bluetooth communication method of claim 17, wherein the BIS events that the sub-apparatuses correspond to are arranged in a sequential manner.

19. The Bluetooth communication method of claim 17, wherein the BIS events that the sub-apparatuses correspond to are arranged in an interleaved manner such that K-th subevents of the BIS intervals of all the sub-apparatuses are arranged in a sequential manner, and K+1 subevents of the BIS intervals of all the sub-apparatuses are arranged in a sequential manner behind the K-th subevents of the BIS intervals of all the sub-apparatuses, in which K is an integer larger than 0.

20. The Bluetooth communication method of claim 15, further comprising:
transmitting a mode switching command by the Bluetooth central apparatus to switch the Bluetooth peripheral apparatus from the normal transmission mode to the bi-directional transmission mode or from the bi-directional transmission mode to the normal transmission mode.
